(19) United States
(12) Patent Application Publication
(10) Pub. No.: US 2020/0226904 A1
(43) Pub. Date: Jul. 16, 2020

(54) PATIENT MONITORING METHOD AND APPARATUS FOR MEDICAL IMAGING DEVICE

(71) Applicant: Siemens Healthcare GmbH, Erlangen (DE)

(72) Inventor: Bin Kuang, Shenzhen (CN)

(73) Assignee: Siemens Healthcare GmbH, Erlangen (DE)

(21) Appl. No.: 16/739,452

(22) Filed: Jan. 10, 2020

(30) Foreign Application Priority Data
Jan. 11, 2019 (CN) 201910026860.5

(51) Int. Cl. G08B 21/04; G06T 7/20; G06F 3/0484

(52) U.S. Cl. CPC G08B 21/0476; G06T 7/20; G06T 2207/20224; G08B 21/043; G06F 3/04842

(57) ABSTRACT

A patient monitoring method and apparatus for a medical imaging device are provided, which subject an examination subject positioned in the medical imaging device to real-time image capture. Two images are sampled spaced apart by a specified time and captured by a camera, and a difference is calculated to obtain a difference image matrix. The difference image matrix is used to determine whether the examination subject has moved using a predetermined threshold. A display presents an image captured by the camera in a pop-up window when it is determined that the examination subject has moved such that a medical imaging scan operating interface and the image captured by the camera are presented together. The display only presents the medical imaging scan operating interface (not an image captured by the camera) when it is determined that the examination subject has not moved.

### CROSS-REFERENCE TO RELATED APPLICATIONS

The present application claims the benefit of the filing date of China patent application no. 201910026860.5, filed on Jan. 11, 2019, the contents of which are incorporated herein by reference in their entirety.

### TECHNICAL FIELD

The present disclosure relates to a patient monitoring method and apparatus for a medical imaging device.

### BACKGROUND

Existing magnetic resonance imaging (MRI) devices can subject an examination subject on a patient table to a scanning operation to obtain a magnetic resonance image of the examination subject, and display the image obtained by scanning on a display (main display) of the MRI device. In the course of scan imaging, it is generally necessary for a user (e.g. a doctor) to monitor the state of the patient. At present, a camera for monitoring the patient in real time is disposed separately on a medical imaging device, and an image of the patient is displayed on another display (secondary display).

Thus, in existing MRI devices, the doctor not only needs to pay attention to the main display used for scanning operations, but also needs to pay attention to the secondary display which displays the state of the patient. Thus, the doctor may be unable to concentrate on the scanning operation as a result of paying attention to the secondary display or, in the event of the patient suffering a mishap, may be unable to discover it in a timely manner. These situations result in reduced operating efficiency when the doctor is performing operations, and in turn have an impact on the efficiency of scanning examinations.

### SUMMARY

In view of the above, the present disclosure proposes a patient monitoring method and apparatus enabling a doctor to concentrate on a scanning operation and prompting the doctor to be careful to observe a patient's condition only in specific circumstances.

An embodiment of the present disclosure provides a patient monitoring method for a medical imaging device, the method using a camera to subject an examination subject positioned in the medical imaging device to real-time image capture; when a medical imaging scan is performed, two images spaced apart by a specified time and captured by the camera are sampled and a difference is calculated to obtain a difference image matrix; when the difference image matrix is greater than a predetermined threshold, it is determined that the examination subject has moved, and an image captured by the camera is displayed in a pop-up window of a display of the medical imaging device, wherein a medical imaging scan operating interface and the image captured by the camera can be displayed together; when the difference image matrix is not greater than the threshold, it is determined that the examination subject has not moved, and the display only displays the medical imaging scan operating interface, not an image captured by the camera.

In the patient monitoring method described above, the difference image matrix may be subjected to a calculation to find the modulus, and the modulus used to make a comparison with the threshold.

In the patient monitoring method described above, when a patient table of the medical imaging device moves, an image captured by the camera is displayed in the pop-up window of the display, and when an alarm of the medical imaging device is operated, an image captured by the camera is displayed in the pop-up window of the display.

In the patient monitoring method described above, when the patient table moves towards a detection region of the medical imaging device in preparation for performing an imaging scan, an image captured by the camera is displayed in the pop-up window of the display; when a patient is positioned in a scanning region to undergo a scan, the displaying of an image captured by the camera is cut off and only a scanning operation page is displayed on the display; if movement of the patient is detected, an image captured by the camera is displayed in the pop-up window of the display; or if an emergency alarm is operated by the patient, an image captured by the camera is displayed in the pop-up window of the display.

Another embodiment of the present disclosure provides a patient monitoring apparatus for a medical imaging device, comprising: a camera, which subjects an examination subject positioned in the medical imaging device to real-time image capture; a movement determining unit, which samples two images spaced apart by a specified time and captured by the camera and calculates a difference to obtain a difference image matrix, determines that the examination subject has moved when the difference image matrix is greater than a predetermined threshold, and determines that the examination subject has not moved when the difference image matrix is not greater than the threshold; a display, which displays an image captured by the camera in a pop-up window when the movement determining unit determines that the examination subject has moved, being able to display a medical imaging scan operating interface and the image captured by the camera together, and only displays the medical imaging scan operating interface, not an image captured by the camera, when the movement determining unit determines that the examination subject has not moved.

The patient monitoring apparatus further comprises an alarm warning unit and a patient table movement detection unit, wherein the alarm warning unit displays an image captured by the camera in the pop-up window of the display when an alarm of the medical imaging device is operated, and the patient table movement detection unit displays an image captured by the camera in the pop-up window of the display when a patient table moves.

The patient monitoring apparatus further comprises a switch unit, which is switched according to signals outputted from the movement determining unit, the alarm warning unit and the patient table movement detection unit such that an image of the camera is displayed on the display.

In the patient monitoring apparatus described above, when the patient table moves towards a detection region of the medical imaging device in preparation for performing an imaging scan, the patient table movement detection unit detects movement of the patient table, and the switch unit displays an image captured by the camera in the pop-up window of the display; when a patient is positioned in a scanning region to undergo a scan, if the movement determining unit does not detect movement of the patient, then the switch unit cuts off the displaying of an image captured by the camera and only displays a scanning operation page on the display, and if the movement determining unit detects movement of the patient, the switch unit displays an image captured by the camera in the pop-up window of the display; or if an emergency alarm is operated by the patient, the switch unit displays an image captured by the camera in the pop-up window of the display.

According to the embodiments above, in the course of the medical imaging scan, an image captured by the camera is only displayed in the display if it is determined that the examination subject has moved; at other times, camera images are not displayed in the display—only the operating interface for scanning is displayed. Thus, the medical imaging device operator (e.g. doctor) does not need to pay attention to the patient throughout the entire process, and need only observe the patient when necessary; thus, the operator is enabled to concentrate more on the medical imaging scan operations, and the medical imaging scan operating efficiency is improved. In addition, since the image captured by the camera is displayed in a window which pops up on the display, the effect of reminding the doctor to pay attention to the patient can be achieved.

In addition, according to the embodiments above, there is no need to provide a separate display for the camera, as is the case in existing medical imaging devices; only one main display for medical imaging scan operations is needed, and camera images need only be displayed on the display when necessary. It is thereby possible to simplify the patient monitoring apparatus for a medical imaging device, reducing the costs of manufacture and maintenance.

### BRIEF DESCRIPTION OF THE DRAWINGS/FIGURES

Preferred embodiments of the present disclosure are described in detail below with reference to the accompanying drawings, to give those skilled in the art a clearer understanding of the abovementioned and other features and advantages of the present disclosure.

FIG. 1 is a block diagram and a patient monitoring method for a magnetic resonance imaging (MRI) device, according to an embodiment of the present disclosure.

FIG. 2 is a structural block diagram of a patient monitoring apparatus for an MRI device, according to an embodiment of the present disclosure.

### KEY TO THE DRAWINGS

10—MRI device;
20—camera;
30—patient table;
40—movement determining unit;
42—alarm warning unit;
44—patient table movement detection unit;
50—switch unit;
60—display

### DETAILED DESCRIPTION

To clarify the object, technical solution, and advantages of the present disclosure, the present disclosure is explained in further detail below by way of embodiments.

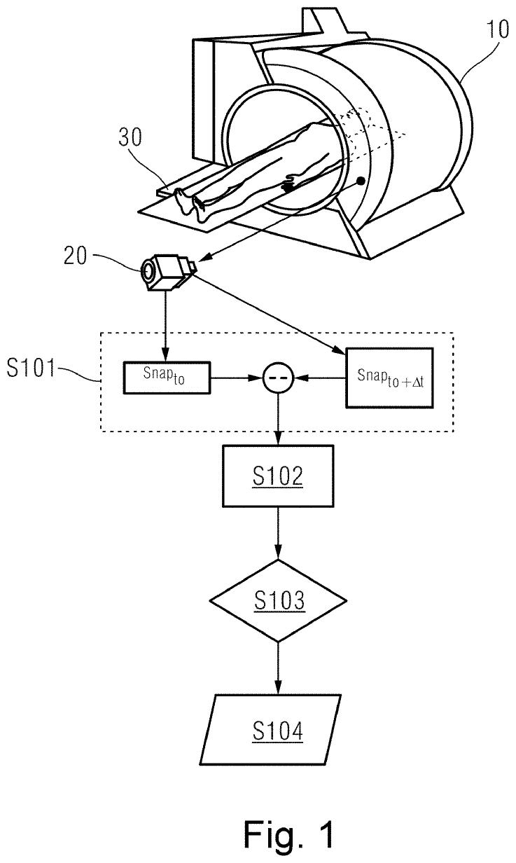

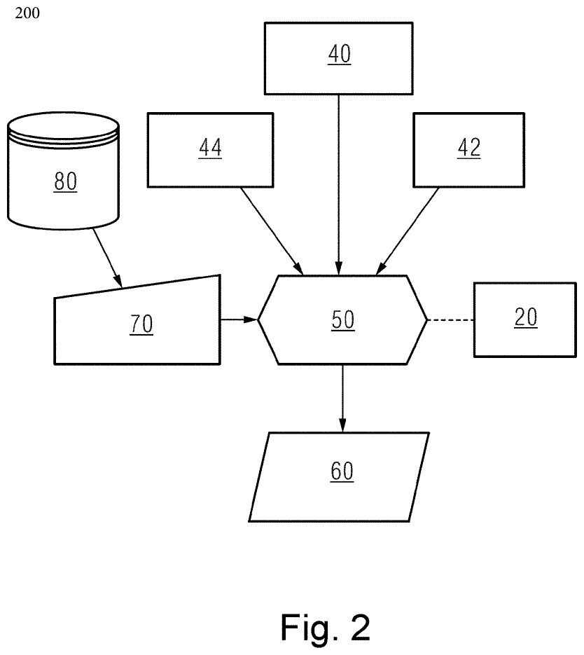

In one embodiment of the present disclosure, a patient monitoring method for an MRI device 10 is shown by way of example. As shown in FIG. 1, the MRI device 10 is configured to scan an examination subject carried on a patient table 30 to obtain a magnetic resonance image of the examination subject, and display the image obtained by scanning on a display 60 (see FIG. 2). In the course of MRI scanning, movement of the examination subject will cause artifacts in the image obtained, and these will affect the doctor's ability to make judgements. Hence, in the course of MRI scanning, a separate camera 20 is configured to monitor the examination subject's movement state in real time (step S101).

Further, in the patient monitoring method of the present disclosure, two images spaced apart by a specified time Δt and captured using the camera 20 are sampled, and a grayscale difference of each pixel is calculated to obtain a difference image matrix (step S102). For example, an image Snapₜ_{₀} of the examination subject captured by the camera 20 is sampled at time t₀, then after a specified time interval Δt, another image Snapₜ_{₀}_{+Δt} is sampled, and a grayscale image difference between the two images is calculated according to Equation 1 below.

Pic_{diff}=Snapₜ_{₀}−Snapₜ_{₀}_{+Δt} Eqn. 1:

Further, the difference image matrix is subjected to a calculation to find an image value that includes, for example, the modulus, and the modulus obtained by calculation is compared with a predetermined threshold (step S103). When the modulus is greater than the predetermined threshold, i.e. Pic_{diff}>threshold, it is determined that the examination subject has moved in the course of scanning. In this situation, a window pops up in the display 60 of the MRI device to display an image captured by the camera 20, and it is thereby possible to display an operating interface for MRI scanning and the image captured by the camera 20 together. When the modulus is not greater than the predetermined threshold, it is determined that the examination subject has not moved, in which case only the MRI scan operating interface is displayed in the display of the MRI device; an image captured by the camera is not displayed (step S104).

According to the embodiment above, in the course of MRI scanning, an image captured by the camera is only displayed in the display if it is determined that the examination subject has moved; at other times, camera images are not displayed in the display—only the operating interface for scanning is displayed. Thus, the magnetic resonance device operator does not need to pay attention to the patient throughout the entire process, and need only observe the patient when necessary; thus, the operator is able to concentrate more on the MRI scanning operations, and the operating efficiency of MRI scanning is improved. In addition, since the image captured by the camera is displayed in a window which pops up on the display, the effect of reminding the doctor to pay attention to the patient can be achieved.

In addition, according to the embodiment above, there is no need to provide a separate display for the camera, as is the case in existing magnetic resonance devices; only one main display for magnetic resonance scanning operations is needed, and camera images need only be displayed on the main display when necessary. It is thereby possible to simplify the patient monitoring apparatus for a magnetic resonance device, reducing the costs of manufacture and maintenance.

In accordance with this embodiment, the specified time interval Δt at which the camera 20 is sampled may for example be, for instance, 1 to 2 seconds, but of course the time interval Δt may be adjusted appropriately to any suitable time according to actual needs or a particular application.

In addition, different values may be used for the predetermined threshold according to different scanning sequences of MRI scanning. Moreover, the threshold may be adjusted appropriately according to different application environments.

In addition, when the patient table 30 carrying the patient of the MRI device moves, an image captured by the camera is displayed in the display.

In addition, when an emergency alarm of the MRI device is operated by the patient, an image captured by the camera is displayed in the display.

Specifically, when the patient lies on the patient table 30 and moves towards a detection region of the magnetic resonance device 10 in preparation for performing an imaging scan, an image captured by the camera 20 is displayed on the display 60. When the patient is positioned in a scanning region to undergo a magnetic resonance scan, only a scanning operation page is displayed in the display if the patient does not move; if it is detected that the patient has moved, an image captured by the camera 20 is displayed in a pop-up window of the display 60. Or, if the patient operates the emergency alarm due to feeling unwell etc. in the course of scan imaging and needing to stop the scan, an image captured by the camera 20 is displayed in a pop-up window of the display 60 so that the doctor can observe the patient's condition in a timely manner.

The case where the patient monitoring method to which the present disclosure relates is applied to an MRI device is shown by way of example in the embodiment above; of course, the patient monitoring method may also be applied to any other medical imaging devices in which it is desired to monitor the patient's condition in the course of scan imaging, such as CT machines, PET machines or X-ray machines, etc.

FIG. 2 shows a structural block diagram of a patient monitoring apparatus for an MRI device according to an embodiment of the present disclosure. In various aspects, the block diagram 200 includes several operational components, which may be implemented with any suitable number and/or type of computer processors, hardware circuitry, software, or combinations thereof. One or more of the operational components of the block diagram 200 may be implemented as part of the MRI device 10 or as separate components that may be communicate with the MRI device 10 and/or the camera 20 or otherwise access the images captured by the camera 20. One or more of the operational components of the block diagram 200 may store or otherwise access a machine-readable storage medium (e.g. a non-transitory computer-readable medium), which includes executable program code that enables a respective operational component to execute the methods and techniques described in the present disclosure, i.e. to execute a part or all of practical operations to realize the function in any of the embodiments as described herein. The storage medium may be configured to provide program codes in the form of a floppy disk, a hard disk, a magneto-optical disk, an optical disk (for example, CD-ROM, CD-R, CD-RW, DVD-ROM, DVD-RAM, DVD-RW, DVD+RW), magnetic tape, non-volatile memory card, ROM, etc. Alternatively, the program codes may be downloaded from a server computer over a communication network (not shown).

The patient monitoring apparatus for the MRI device 10 according to an embodiment of the present disclosure is explained below according to the block diagram 200 as shown in FIG. 2, which illustrates several operation components. The patient monitoring apparatus at least comprises: a camera 20, a movement determining unit 40, and a display 60. In various embodiments, the patient monitoring apparatus and/or the block diagram 200 may include additional, less, or alternate components.

The camera 20 subjects an examination subject (e.g. a patient) positioned in the MRI device to real-time image capture. During an MRI scan, the movement determining unit 40 samples two images spaced apart by a specified time Δt and captured by the camera 20, and calculates a grayscale difference of each pixel point to obtain a difference image matrix. For example, an image Snapₜ_{₀} of the examination subject captured by the camera 20 is sampled at time t₀, then after a specified time interval Δt, another image Snapₜ_{₀}_{+Δt} is sampled, and a grayscale difference of each pixel point between the two images is calculated according to Eqn. 1 above, to obtain a difference image matrix. Further, the difference image matrix is subjected to a calculation to find the modulus, and the modulus obtained by calculation is compared with a predetermined threshold. When the modulus is greater than the predetermined threshold, i.e. Pic_{diff}>threshold, it is determined that the examination subject has moved in the course of scanning. When the modulus is not greater than the predetermined threshold, it is determined that the examination subject has not moved.

When the movement determining unit 40 determines that the examination subject has moved, a window pops up in the display 60 to display a picture captured by the camera 20, so the MRI scan operating interface and the picture captured by the camera 20 are thereby displayed on the display together. When the movement determining unit 40 determines that the examination subject has not moved, only the MRI scan operating interface is displayed in the display 60—the picture captured by the camera 20 is not displayed.

In addition, the patient monitoring apparatus of this embodiment may further comprise an alarm warning unit (e.g. an emergency alarm apparatus) 42 and a patient table movement detection unit 44. When an emergency alarm of the magnetic resonance device is operated by the patient, the alarm warning unit 42 displays an image captured by the camera 20 in the display 60. In addition, when the patient table movement detection unit 44 detects that the patient table 30 has moved, an image captured by the camera 20 is displayed in the display 60.

In addition, in accordance with the present embodiment, a switch unit 50 may be used to switch between signals outputted from the movement determining unit 40, the alarm warning unit 42, and the patient table movement detection unit.

Specifically, when the patient lies on the patient table 30 and moves towards a detection region of the magnetic resonance device 10 in preparation for performing an imaging scan, the patient table movement detection unit 44 detects the movement of the patient table, the switch unit 50 connects a signal of the camera 20 to the display 60, and an image captured by the camera 20 is displayed in a pop-up window of the display 60. When the patient is positioned in a scanning region to undergo a scan, if the movement determining unit 40 does not detect movement of the patient, then the switch unit 50 cuts off (i.e. terminates) the displaying of the image captured by the camera 20 and only displays a scanning operation page; if the movement determining unit 40 detects movement of the patient, the switch unit 50 displays an image captured by the camera 20 on the display 60. Or, if the patient operates the emergency alarm due to feeling unwell, anxiety, etc., in the course of scan imaging, the switch unit 50 displays an image captured by the camera 20 in the display 60 so that the doctor can observe the patient's condition in a timely manner.

According to the embodiment above, in the course of MRI scanning, an image captured by the camera is only displayed in the display if it is determined that the examination subject has moved; at other times, camera images are not displayed in the display—only the operating interface for scanning is displayed. Thus, the magnetic resonance device operator does not need to pay attention to the patient throughout the entire process, and need only observe the patient when necessary; thus, the operator is enabled to concentrate more on the MRI scanning operations, and the operating efficiency of MRI scanning is improved. In addition, since the image captured by the camera is displayed in a window that pops up on the display, the effect of reminding the doctor to pay attention to and check the patient can be achieved.

In addition, according to the embodiment above, there is no need to provide a separate display for the camera, as is the case in existing magnetic resonance devices; only one main display for magnetic resonance scanning operations is needed, and camera images need only be displayed on the display when necessary. It is thus possible to simplify the patient monitoring apparatus for a magnetic resonance device, thereby reducing the costs of manufacture and maintenance.

In accordance with the present embodiment, a user setting apparatus 70 may be used to set the specified time interval Δt at which the camera 20 is sampled to, for example, 1 to 2 seconds, according to different scanning sequences to be used which are stored in a sequence storage apparatus 80. Again, the time interval Δt may be adjusted appropriately to any suitable time according actual needs or a particular application.

In addition, different values may also be used for the predetermined threshold according to different scanning sequences of MRI scanning or different patient situations. Moreover, the threshold may be adjusted appropriately according to different application environments.

In addition, when the patient table 30 carrying the patient of the MRI device moves, an image captured by the camera is displayed in the display.

In addition, when the emergency alarm of the MRI device is operated, an image captured by the camera is displayed in the display.

The case where the patient monitoring apparatus to which the present disclosure relates is applied to an MRI device is shown by way of example in the embodiment above. Again, the patient monitoring method may also be applied to other medical imaging devices in which the patient's condition needs to be monitored in the course of scan imaging, such as CT machines, PET machines or X-ray machines, etc. In this case, different values may be used for the specified time interval Δt at which the camera 20 is sampled and for the predetermined threshold according to different scanning conditions.

The above-mentioned embodiments are preferred embodiments of the present disclosure provided by way of example, and should not be interpreted as restricting or otherwise limiting the present disclosure to these specific examples. Without departing the spirit and principle of the present disclosure, modifications, equivalent replacements, and improvements all fall within the scope of protection of the present disclosure.

What is claimed is:

1. A patient monitoring method for a medical imaging device, the method comprising:
upon performing a medical imaging scan with the medical imaging device, capturing, via a camera, a first image and a second image of a patient positioned in the medical imaging device;
sampling, via one or more processors, the first image and the second image during a first time interval and a second time interval, respectively, that are separated by a predetermined time period;
calculating, via one or more processors, a difference between the first and the second sampled images to obtain a difference image matrix;
calculating, via one or more processors, an image value based upon the difference image matrix;
determining, via one or more processors, that the patient has moved when the image value is greater than a predetermined threshold, and in response displaying an image captured by the camera in a pop-up window of a display of the medical imaging device together with a medical imaging scan operating interface associated with the medical imaging device; and
determining, via one or more processors, that the patient has not moved when the image value is not greater than the predetermined threshold, and in response displaying the medical imaging scan operating interface without an image captured by the camera.

2. The patient monitoring method as claimed in claim 1, wherein the act of calculating the image value comprises calculating, as the image value, a modulus of the difference image matrix.

3. The patient monitoring method as claimed in claim 1, further comprising:
displaying an image captured by the camera in the pop-up window of the display in response to movement of a patient table of the medical imaging device when the patient is positioned in a scanning region of the medical imaging device to undergo a scan operation.

4. The patient monitoring method as claimed in claim 1, further comprising:
displaying an image captured by the camera in the pop-up window of the display in response to an alarm of the medical imaging device being operated by the patient.

5. The patient monitoring method as claimed in claim 3, wherein the act of displaying the image captured by the camera in the pop-up window of the display comprises:
displaying the image in response to movement of the patient table towards a detection region of the medical imaging device in preparation for performing an imaging scan.

6. The patient monitoring method as claimed in claim 5, further comprising:
terminating the displaying of the image captured by the camera on the display in response to movement of the patient not being detected such that only a scanning operation page associated with the medical imaging device is displayed; and
when movement of the patient is detected, displaying an image captured by the camera in a pop-up window of a display of the medical imaging device.

7. The patient monitoring method as claimed in claim 5, further comprising:
displaying an image captured by the camera in the pop-up window of the display in response to an emergency alarm operated by the patient.

8. A patient monitoring apparatus for a medical imaging device, comprising:
a camera configured to capture a first image and a second image of a patient positioned in the medical imaging device;
movement determining circuitry configured to:
sample the first image and the second image during a first time interval and a second time interval, respectively, that are separated by a predetermined time period;
calculate a difference between the first and the second sampled images to obtain a difference image matrix;
calculate an image value based upon the difference image matrix;
determine whether the patient has moved based upon a comparison of the image value to a predetermined threshold; and
a display configured to:
present an image captured by the camera in a pop-up window of a display of the medical imaging device together with a medical imaging scan operating interface associated with the medical imaging device when movement of the patient is determined, and
present the medical imaging scan operating interface without an image captured by the camera when movement of the patient is not determined.

9. The patient monitoring apparatus as claimed in claim 8, further comprising:
patient table movement detection circuitry configured to cause the display to present an image captured by the camera in the pop-up window of the display when a patient table moves; and
alarm warning circuitry configured to cause the display to present an image captured by the camera in the pop-up window of the display when an alarm of the medical imaging device is operated.

10. The patient monitoring apparatus as claimed in claim 9, further comprising:
switching circuitry configured to output a signal associated with one of the movement determining circuitry, the alarm warning circuitry, and the patient table movement detection circuitry such that an image captured via the camera is selectively presented on the display based upon the signal.

11. The patient monitoring apparatus as claimed in claim 10, wherein the switch unit is configured to output the signal to cause the display to present an image captured by the camera in the pop-up window of the display in response to the patient table movement detection circuitry detecting movement of the patient table moving towards a detection region of the medical imaging device in preparation for performing an imaging scan.

12. The patient monitoring apparatus as claimed in claim 11, wherein the switch unit is configured to output the signal to cause the display to (i) terminate the displaying of the image captured by the camera on the display in response to the movement determining circuitry not detecting movement of the patient such that only a scanning operation page associated with the medical imaging device is displayed, and (ii) display the image captured by the camera on the display in response to the movement determining circuitry detecting movement of the patient.

13. The patient monitoring apparatus as claimed in claim 11, wherein the switch unit is configured to output the signal to cause the display to display the image captured by the camera on the display in response to an emergency alarm being operated by the patient.
